(19) United States
(12) Patent Application Publication
(10) Pub. No.: US 2007/0156569 A1
(43) Pub. Date: Jul. 5, 2007

(54) Date detector

(76) Inventor: Peter Vignet, San Francisco, CA (US)

Correspondence Address: HOLLAND & KNIGHT, LLP, 10 ST. JAMES AVENUE, BOSTON, MA, 02116, US

(21) Appl. No.: 11/326,222

(22) Filed: Jan. 5, 2006

(51) Int. Cl. G06Q 40/00

(52) U.S. Cl. 705/37; 705/36 R

(57) ABSTRACT

Methods and apparatus, including computer program products, for a date detector. A computer-implemented method of displaying information on a computer display device includes loading a store of financial data, receiving a calendar start date, receiving a calendar end date, comparing the received calendar start date and the received calendar end date to implicit dates of financial periods, and matching the received calendar start date to a nearest previous implicit financial start date. The method matches the received calendar end date to a nearest next implicit financial end date, sets the received calendar start date to the nearest previous implicit financial start date, sets the received calendar end date to the nearest next implicit financial end date, and displays financial data consistent with the nearest previous implicit financial start date and the nearest next implicit end date in a user interface (UI) table on the computer display device.

### BACKGROUND

The present invention relates to data processing by digital computer, and more particularly to a date detector.

User interfaces (UIs) are an integral part of many business enterprise software applications. For example, Web Dynpro from SAP AG enables companies to model and design UIs cost-effectively and precisely. A Web Dynpro application includes a set of views, navigation between the views, concepts for managing the views and determining their sequence, a context for keeping session data, and the business logic of the application.

One type of UI element, a Web Dynpro Calendar, provides for the two-dimensional display of dates. The Web Dynpro calendar can be used in a variety of business applications.

### SUMMARY

The present invention provides methods and apparatus, including computer program products, for a date detector.

In one aspect, the invention features a method including loading a store of financial data, receiving a calendar start date, receiving a calendar end date, comparing the received calendar start date and the received calendar end date to implicit dates of financial periods, and matching the received calendar start date to a nearest previous implicit financial start date.

In embodiments, the method can include matching the received calendar end date to a nearest next implicit financial end date. The method can include setting the received calendar start date to the nearest previous implicit financial start date, and setting the received calendar end date to the nearest next implicit financial end date.

The method can include displaying financial data consistent with the nearest previous implicit financial start date and the nearest next implicit end date in a user interface (UI) table on the computer display device.

Receiving can include input through a date detector UI. The date detector UI can include a calendar start date input area, a calendar end date input area, and an apply button.

The invention can be implemented to realize one or more of the following advantages.

When a date detector process is given an inadequate calendar date to show a range of financial planning periods, it identifies the planning periods involved in the entered date range and returns the correct period identifiers. The process also returns the exact calendar dates covering these financial planning periods. If a UI table user interface includes a column navigator, the date detector returns the exact calendar dates covering the new visible financial planning periods.

Since an SAP R/3 back end uses a period ID pattern in many areas, the date detector process can be used for many planning SAP Web Dynpro Applications.

The date detector process can be implemented as Java class or a common DC.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of an exemplary UI table user interface (UI).

FIG. 3 is a block diagram of an exemplary UI table.

FIG. 4 is a block diagram of an exemplary UI table.

FIG. 5 is a block diagram of an exemplary UI table.

FIG. 6 is a block diagram of an exemplary UI table.

FIG. 7 is a flow diagram.

FIG. 8 is a block diagram of an exemplary UI table.

FIG. 9 is a block diagram of an exemplary UI table.

FIG. 10 is a block diagram of an exemplary UI table.

Like reference numbers and designations in the various drawings indicate like

### DETAILED DESCRIPTION

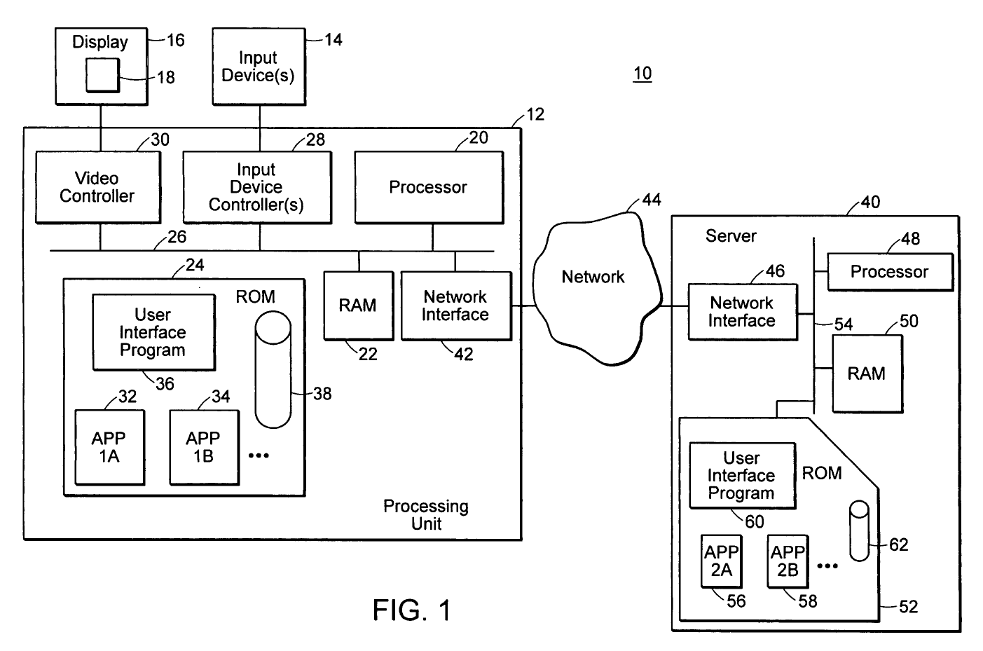

As shown in FIG. 1, an exemplary computer system 10 includes a processing unit 12, one or more input devices 14, and a display device 16, upon which a user is presented displays. The display device 16 has a video screen 18 upon which displays appear.

The processing unit 12 can include a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The system 10 is not limited to a personal computer (PC), but could include a personal digital assistant (PDA), a terminal, a workstation, or other such device.

ROM 24 provides non-volatile data storage for various application programs. In the example shown, a number of different application programs 32, 34, are stored in ROM 24. Also stored in ROM 24 is a user interface (UI) program 36 designed to work in concert with each of the application programs 32, 34. This is conceptually depicted by the UI program 36 shown as a layer on top of the application programs 32, 34. With such a design, UI program modules common to several application programs need not be duplicated in each of the application programs 32, 34. In addition, such a design may enable a common “look-and-feel” to the UI for the different program applications 32, 34. In other examples, the UI program, or module, is not a common program or module for more than one program application. In still other examples, the components described can be combined or separated in various manners, and can be stored in various manners, such as on various non-volatile storage medium.

Programs 32, 34, 36 have program instructions that can be loaded into RAM 22 during operation. Processor 20 then executes the program instructions, as required, to perform desired program functions.

Also stored in ROM 24 are various data in database 38. Database 38 includes data needed or generated during operation of the application programs 32, 34. Although only a single database 38 is shown that serves as a common database for all applications 32, 34, in other examples there can be separate databases for one, or more, of the applications 32, 34.

System 10 includes connection to a server 40 and a network interface 42, connected to its data bus 26. As such, system 10 can access server 40 over network 44 to run applications residing on the server 40. Network 44 can be, for example, a Local Area Network (LAN), Wide Area Network (WAN), or the Internet.

The server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, as well as a common user interface program 60 for the application programs 56, 58. ROM 52, in this example, includes data stored in database 62, although in other implementations separate databases or a separate database server may be required.

R/3 is the comprehensive set of integrated business applications from SAP AG, the German company that is the market and technology leader in business application software. R/3 uses the client/server model and provides the ability to store, retrieve, analyze, and process in many ways corporate data for financial analysis, production operation, human resource management, and most other business processes. SAP's Material Resource Planning (MRP) business application is a software application that uses bill of material, routing, inventory, work order, sales order, purchase order, transfer order, and other information to calculate requirements for materials. The smallest granularity for R/3 and MRP financial periods for financial forecasts or capacity categories (or groups) forecast is one month. Periods can be larger than a month and are considered multiples of a month. For example, bimonthly, quarterly, semi-annually, annually, bi-annually, tri-annually, and so forth. A period is identified by a period identification (ID). A period ID has a format YYYYMM, where YYYY refers to a year and MM refers to a month.

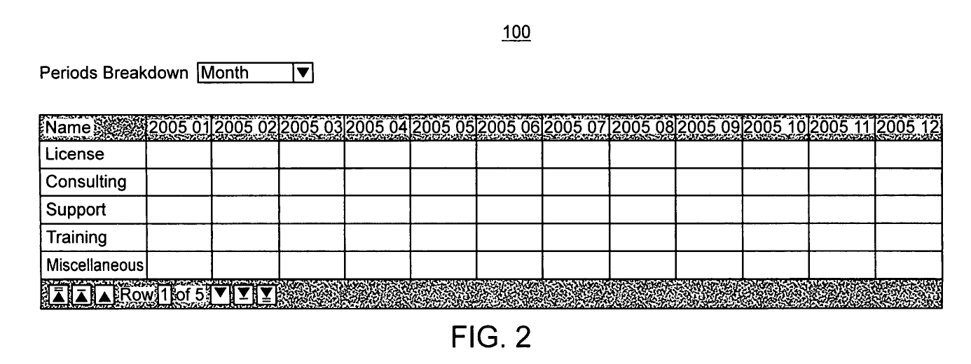

As shown in FIG. 2, a Web Dynpro UI table 100 displays monthly financial periods, where the column headings reflect the period ID YYYY MM. In UI table 100, the month MM of the period ID is the starting month.

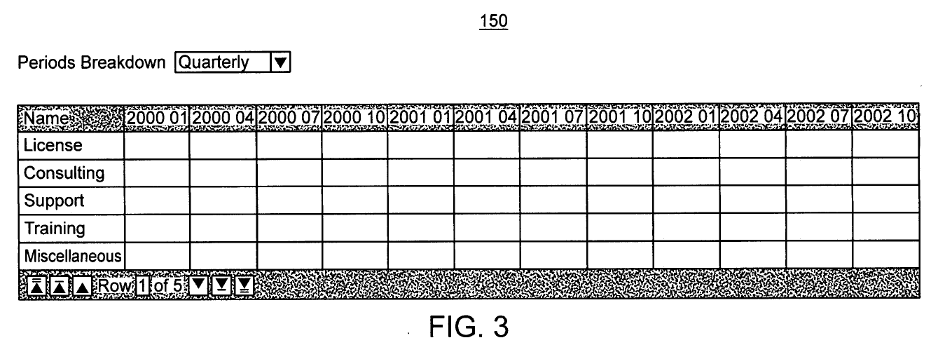

As shown in FIG. 3, a Web Dynpro UI table 150 displays quarterly periods, where the quarterly period IDs, assuming a fiscal year begins in January, are in the format YYYY01, YYYY04, YYYY07, YYYY10. UI table 150 includes financial periods for the year 2000 and 2001 having a quarterly pattern where the MM part of the period ID is the starting month of the period.

A planning period can also include a planning type. A planning type indicates the monthly granularity of the period (e.g., monthly, bimonthly, and so forth). SAP R/3 and SAP MRP back end systems use planning periods and period IDs with the format YYYYMM in many different applications.

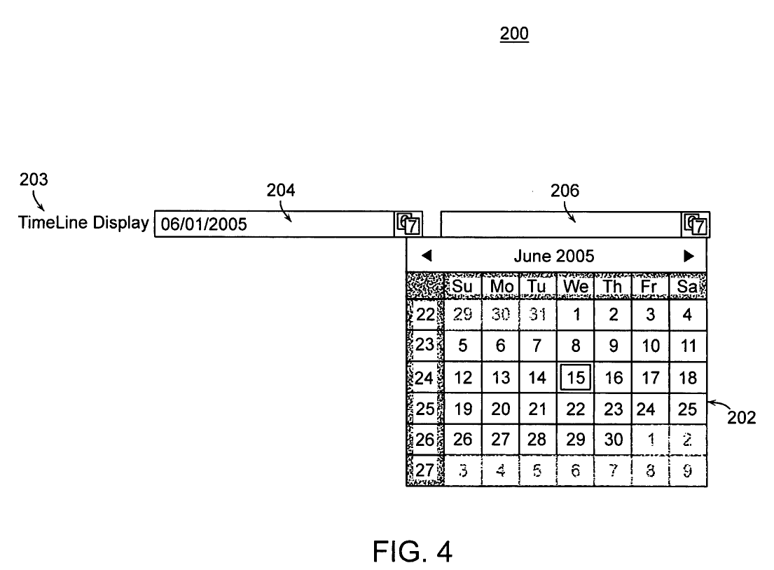

As shown in FIG. 4, a Web Dynpro date input field 200 can display a calendar 202 in which a user can navigate month to month and pick a desired date. In this particular example, date input field 203 is a time line display that includes a calendar start date 204 and a calendar end date 206.

As described above, when a user desires to retrieve financial periods or a range of financial periods, the user can call them by their period IDs. In this example, the user must know the starting of a fiscal year and the planning type (e.g., monthly, bimonthly, quarterly, and so forth). This requires the user to do a manual calculation to establish the period IDs to display.

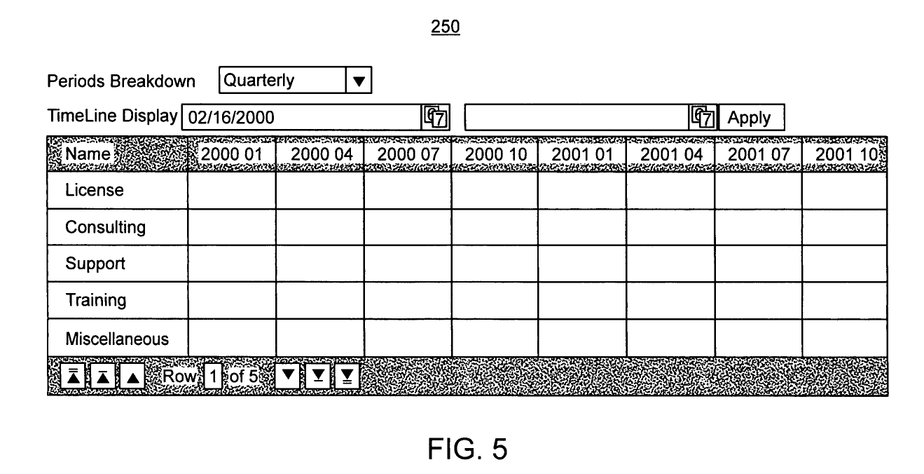

A more user-friendly approach is to enable the user to pick a period ID from a calendar. However, the month of the calendar dates selected may not be for the Period ID. As shown in FIG. 5, the user selected a start month of 02 (i.e., MM=02) but quarterly financial planning does not exist for the period ID YYYY02. The column headers in UI table 250 show period IDs (YYYYMM). Since the financial periods are quarterly periods there are no period IDs with MM=02 in any column headers. Only the periods YYYY01 and YYYY04 exist. In other words, the calendar date has to detect the correct financial period it belongs to, i.e., in this example, it is the period YYYY01.

The problem is similar if the calendar end date entered is, for example, 06/08/2000. There is no period ID finishing with a MM=06 for quarterly planning. If one considers a calendar start date and a calendar end date, i.e., a calendar date range, a problem is to find out which financial planning periods are affected by the calendar date range. In summary, the first problem is to identify the correct financial periods requested from the calendar start date and end date.

A second problem is that the calendar date has a day. A user can pick a date with a day that is in the middle of the month. In fact, a start date of a financial period is always the first day of the first month of this financial period, and the end day of the financial period is always the last day of the last month of the financial period. To be accurate, if we consider financial periods that are annual or bigger than annual, the start date of a financial period is always the first day of the first month of the first year this financial period, and the end date of a financial period is always the last day of the last month of the last year of this financial period. In the description that follows, we describe examples that have financial planning periods smaller than a year.

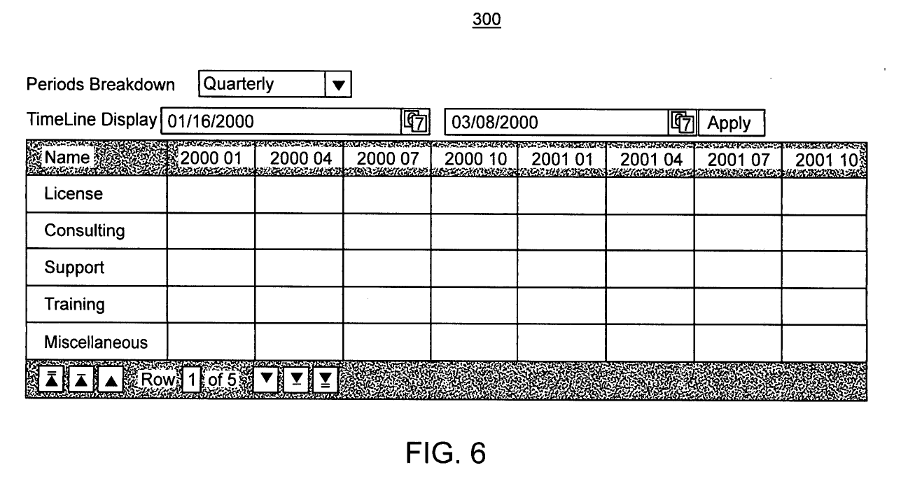

As shown in FIG. 6, a UI table 300 has the user picking the sixteenth of the month for a starting date and the eight of another month for the ending date. A correct starting date should be 01/01/2000 and a correct ending date should be 03/31/2000. In other words, a financial period has two implicit calendar dates attached to it that are the start day of a financial period (the first day of the month of this financial period) and the end date of a financial period (the last day of the last month of this financial period). In one case, the problem is to provide, from an inadequate calendar start date and end date, the correct financial periods and to correct the requested calendar dates to reflect exactly the dates of the financial periods. In another case, when a column navigator is used, the problem is to provide, from an inadequate calendar start date and end date, the correct financial periods to correct the requested calendar dates to reflect exactly the dates of the financial periods, and to update the calendar dates shown when the user navigates the UI table columns (financial periods).

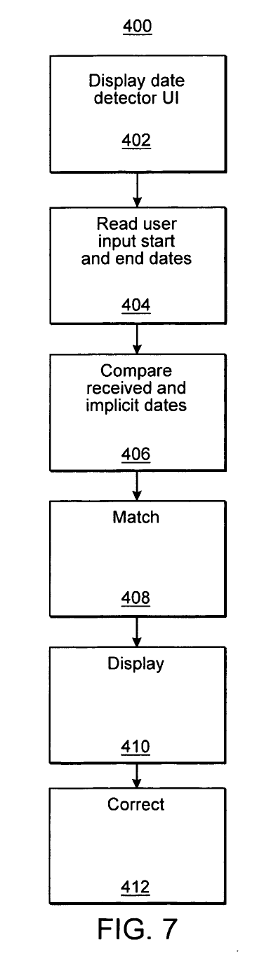

As shown in FIG. 7, RAM 22 includes a date detector process 400, which solves these and other date-related problems. Date detector process 400 includes displaying (402) a date detector user interface (UI). Process 400 reads (404) a user entered calendar end date and a calendar start date. Process 400 compares (406) the entered calendar start date and calendar end date to the implicit dates of the financial periods and matches (408) them to the previous nearest implicit financial date if it is the start date, or to the nearest next implicit financial date if it is the end date. Process 400 displays (410) the identified financial periods and corrects (412) the user entered calendar dates to reflect the correct implicit calendar start date of the first financial period shown and the correct implicit en d date of the last financial period shown.

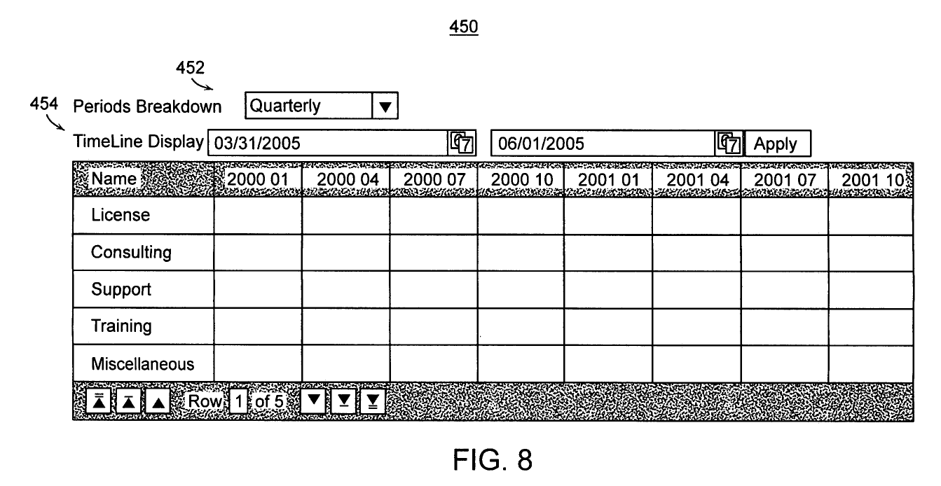

An example is shown in FIG. 8, in which a UI table 450 includes a periods breakdown input box 452 and a date detector UI 454. In this example, a user has selected quarterly financial planning with a start date of 03/31/2005 and an end date of 06/01/2005.

Here, it should be recognized that there is no period MM=03 and no period MM=06 for quarterly financial planning. In addition, the day of the entered calendar start date is the last day of the month and the day of the entered calendar end date is the first day of the month.

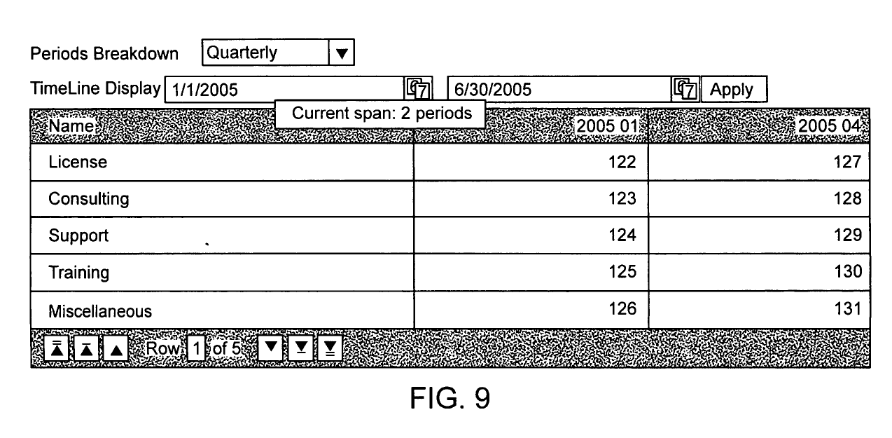

Once the date detector process 400 receives the start and end dates and the user presses “apply,” two quarterly financial periods are detected, i.e., 200501 and 200504. Process 400 recognizes that the user calendar start date falls in the period ID 200501 (period ID is in the column header) and the user calendar end date falls in the period ID 200504. Process 400 recognizes that the implicit calendar start date of the financial period ID=200501 is 01/01/2005 and that the implicit calendar end date of the financial period ID=200504 is 6/30/2005. As shown in FIG. 9, these implicit dates are now reflected in the calendar input field dates of the date detector UI. They are now 1/1/2005 (instead of 03/31/2005) and 6/30/2005 (instead of 06/01/2005)

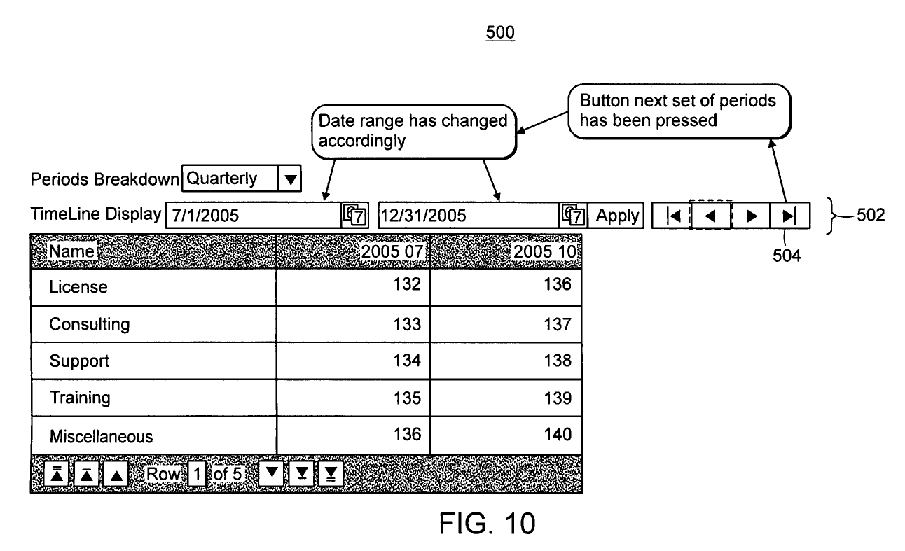

As shown in FIG. 10, a UI table 500 includes a column navigator 502. In this example, the user has pressed a shift to the right button 504 for a set of next periods. The date detector process 400 recognizes that the right shift is two columns and adjusts to accommodate the changes. UI table 500 illustrates that the periods have been shifted to the right for a span of two periods. The new periods are 2005 07 and 2005 10, and the date detector process 400 displays the current period range 7/1/2005 to 12/31/2005.

The date detector process 400 introduces a concept of fuzzy calendar dates to identify R/3 planning periods. An R/3 planning period is identified by the concatenation of its start year and start month. The date detector process 400 is a user friendly tool that helps a user to retrieve the ranges of financial planning periods. The user does not have to know the period's planning type of the periods. The date detector process 400 detects the period's planning type and structure and returns to the user the planning periods and their exact date ranges. The date detector process 400 can be associated with a column navigator and reflects the visible period range when the visibility of the UI table periods change.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method of displaying information on a computer display device, the method comprising:
loading a store of financial data;
receiving a calendar start date;
receiving a calendar end date;
comparing the received calendar start date and the received calendar end date to implicit dates of financial periods; and
matching the received calendar start date to a nearest previous implicit financial start date.

2. The computer-implemented method of claim 1 further comprising:
matching the received calendar end date to a nearest next implicit financial end date.

3. The computer-implemented method of claim 2 further comprising:
setting the received calendar start date to the nearest previous implicit financial start date; and
setting the received calendar end date to the nearest next implicit financial end date.

4. The computer-implemented method of claim 3 further comprising:
displaying financial data consistent with the nearest previous implicit financial start date and the nearest next implicit end date in a user interface (UI) table on the computer display device.

5. The computer-implemented method of claim 1 wherein receiving comprises input through a date detector UI.

6. The computer-implemented method of claim 5 wherein the date detector UI comprises:
a calendar start date input area;
a calendar end date input area; and
an apply button.

7. A computer system comprising:
a display device;
a central processing unit; and
a memory, the memory comprising:
means for loading a store of financial data;
means for receiving a calendar start date;
means for receiving a calendar end date;
means for comparing the received calendar start date and the received calendar end date to implicit dates of financial periods;
means for matching the received calendar start date to a nearest previous implicit financial start date; and
means matching the received calendar end date to a nearest next implicit financial end date.

8. The computer system of claim 7 wherein the memory further comprises:
means for setting the received calendar start date to the nearest previous implicit financial start date; and
means setting the received calendar end date to the nearest next implicit financial end date.

9. The computer system of claim 8 wherein the memory further comprises:
means for displaying financial data consistent with the nearest previous implicit financial start date and the nearest next implicit end date in a user interface (UI) table on the display device.

10. A computer program product, tangibly embodied in an information carrier, for providing display information on a display device of a computer system, the computer program product being operable to cause data processing apparatus to:
load a store of financial data;
receive a calendar start date;
receive a calendar end date;
compare the received calendar start date and the received calendar end date to implicit dates of financial periods;
match the received calendar start date to a nearest previous implicit financial start date; and
match the received calendar end date to a nearest next implicit financial end date.

11. The computer program product of claim 10 further comprising instructions to:
set the received calendar start date to the nearest previous implicit financial start date; and
set the received calendar end date to the nearest next implicit financial end date.

12. The computer program product of claim 11 further comprising instructions to:
display financial data consistent with the nearest previous implicit financial start date and the nearest next implicit end date in a user interface (UI) table on the computer display device.

13. The computer program product of claim 12 wherein the receiving comprises input through a date detector UI.

14. The computer program product of claim 13 wherein the date detector UI comprises:
a calendar start date input area;
a calendar end date input area; and
an apply button.
